(19) United States
(12) Patent Application Publication
(10) Pub. No.: US 2007/0086212 A1
(43) Pub. Date: Apr. 19, 2007

(54) Liquid crystal display device with detachable light source

(75) Inventor: Chien-Chung Fang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/580,475

(22) Filed: Oct. 13, 2006

(30) Foreign Application Priority Data
Oct. 14, 2005 (TW) 94135968

(51) Int. Cl. F21V 7/04

(52) U.S. Cl. 362/633

(57) ABSTRACT

An exemplary liquid crystal display device (200) includes a top frame (210), a light source (240) having at least one lamp (241) and a reflective cover (242) disposed adjacent to the at least one lamp; a back plate (260); a fastening member (270) having a bottom plate portion (272) detachably engaged with the back plate and a side plate portion (271) detachably engaged with the top frame, whereby the reflective cover of the light source being engaged with the bottom plate portion; and a liquid crystal display panel (220) fixed in position above the back plate by the top frame. The process of exchanging the at least one lamp does not require disassembly of the whole liquid crystal display device. Further, the whole light source itself may be conveniently exchanged if needed.

### FIELD OF THE INVENTION

The present invention relates to liquid crystal display (LCD) devices, and more particularly to an LCD device with exchangeable light sources.

### BACKGROUND

A typical LCD device includes an LCD panel, and a backlight module mounted under the LCD panel for supplying light beams thereto. The backlight module mainly includes a light source and a light guide plate. The light guide plate is generally made of a transparent acrylic plastic, and is used for guiding light beams emitted from the light source in order to uniformly illuminate the LCD panel.

Referring to FIG. 4, a conventional LCD device 100 includes a light guide plate 110, a light source 120, a plastic frame 130, a back plate 140, a top frame 150, and an LCD panel 160.

The light guide plate 110 includes a light output surface 111, a light incident surface 112 adjacent to the light output surface 111, and a bottom surface 113 opposite to the light output surface 111. The light source 120 includes two lamps 121 and a reflective cover 122. The lamps 121 are CCFLs (cold cathode fluorescent lamps), each of which is disposed adjacent to the light incident surface 112. The reflective cover 122 covers the lamps 121 for concentrating and guiding the light beams emitted by the lamps 121 to transmit toward the light incident surface 112.

The back plate 140 engages with the top frame 150 as well as the plastic frame 130 to form a space (not labeled) for accommodating and fastening the light guide plate 110 and the light source 120 therein. The LCD panel 160 is supported on the plastic frame 130, and is fixed in position by the top frame 150.

In assembly of the LCD device 100, firstly, the light source 120 is disposed on the back plate 140 to form a subassembly. The light guide plate 110, the plastic frame 130, and the LCD panel 160 are disposed in that order in the subassembly. The top frame 150 is fixed to the back plate 140, thereby fastening the light guide plate 110, the light source 120, and the LCD panel 160 in position. Thus the LCD device 100 is obtained. However, if either of the lamps 121 or the whole light source 120 needs to be replaced, the whole LCD device 100 has to be disassembled. This makes the process of replacement unduly burdensome.

Accordingly, what is needed is an LCD device that can overcome the above-described deficiencies.

### SUMMARY

An exemplary liquid crystal display device includes a top frame, a light source having at least one lamp and a reflective cover disposed adjacent to the at least one lamp; a back plate; a fastening member having a bottom plate portion detachably engaged with the back plate and a side plate portion detachably engaged with the top frame, whereby the reflective cover of the light source being engaged with the bottom plate portion; and a liquid crystal display panel fixed in position above the back plate by the top frame. The process of exchanging the at least one lamp does not require disassembly of the whole liquid crystal display device. Further, the whole light source itself may be conveniently exchanged if needed.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a cross-sectional view of an LCD device according to a first embodiment of the present invention.

FIG. 2 is an exploded view of a right side portion of the LCD device of FIG. 1.

FIG. 3 is a cross-sectional view of an LCD device according to a second embodiment of the present invention.

FIG. 4 is a cross-sectional view of a side portion of a conventional LCD device.

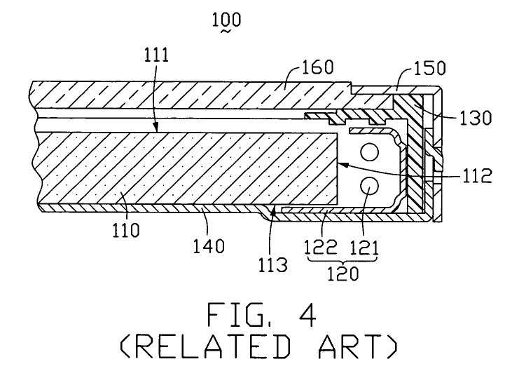

### DETAILED DESCRIPTION OF PREFERRED EMBODIMENTS

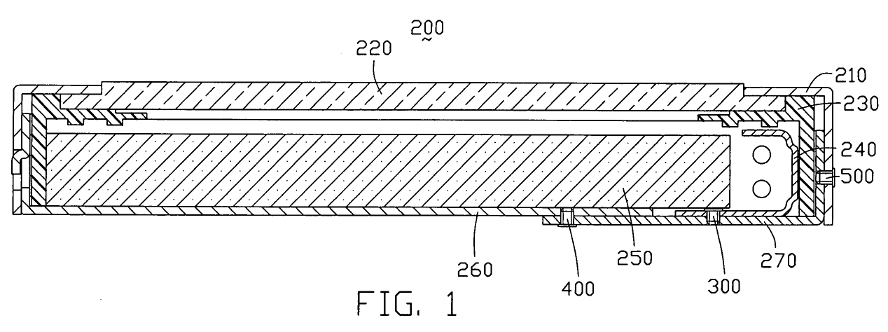

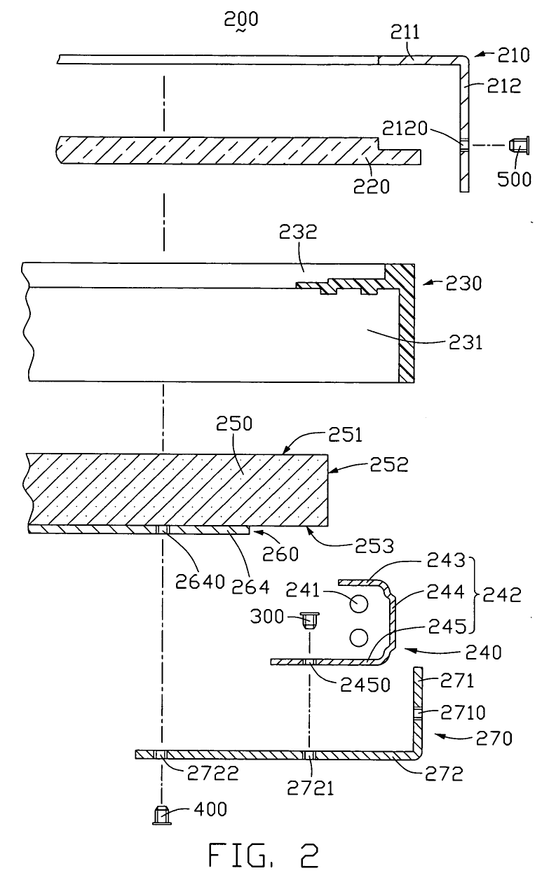

Referring to FIGS. 1-2, an LCD device 200 according to a first embodiment of the present invention includes a top frame 210, an LCD panel 220, a plastic frame 230, a light source 240, a light guide plate 250, a back plate 260, and a fastening plate 270.

The light guide plate 250 includes a light output surface 251, a light incident surface 252 adjacent to the light output surface 251, and a bottom surface 253 opposite to the light output surface 251. The light source 240 includes two lamps 241 and a reflective cover 242. The lamps 241 are typically CCFLs (cold cathode fluorescent lamps), each of which is disposed adjacent to the light incident surface 252. The reflective cover 242 includes a horizontal first plate portion 243, a vertical second plate portion 244, and a horizontal third plate portion 245. The second plate portion 244 extends vertically down from an end of the first plate portion 243, and the third plate portion 245 extends horizontally inwardly from a bottom end of the second plate portion 244. The third plate portion 245 includes a screw hole 2450 thereat. The reflective cover 242 covers the lamps 241 for concentrating and guiding the light beams emitted by the lamps 241 to transmit toward the light incident surface 252.

The back plate 260 is attached to the bottom surface 253 of the light guide plate 250. The back plate 260 includes a screw hole 2640 disposed at a portion thereof adjacent to the light incident surface 252 of the light guide plate 250.

The fastening plate 270 includes a vertical side plate portion 271, and a bottom plate portion 272 extended horizontally inwardly from a bottom end of the side plate portion 271. The bottom plate portion 272 includes a screw hole 2721 corresponding to the screw hole 2450 of the third plate portion 245 of the reflective cover 242, and a screw hole 2722 corresponding to the screw hole 2640 of the back plate 260. The side plate portion 271 includes a screw hole 2710. The fastening plate 270 may made of iron; alloy, or another metallic material.

The plastic frame 230 defines a first space 231 for accommodating the light guide plate 250 and the light source 240, and a second space 232 for accommodating the LCD panel 220.

The top frame 210 has a bezel 211 and a side plate portion 212. The side plate portion 212 includes a screw hole 2120 corresponding to the screw hole 2710 of the side plate portion 271 of the fastening plate 270.

In assembly, a screw 300 is inserted into the screw hole 2450 of the reflective cover 242 and the screw hole 2721 of the fastening plate 272 so as to fix the reflective cover 242 and the fastening plate 272 together. A screw 400 is inserted into the screw hole 2722 of the fastening plate 272 and the screw hole 2640 of the back plate 260 so as to fix the fastening plate 272 and the back plate 260 together. The lamps 241 are disposed adjacent to the reflective cover 242. The light guide plate 250 is disposed on the back plate 260 such that the light incident surface 252 is adjacent to the lamps 241. Once this subassembly is obtained, the plastic frame 230 and the LCD panel 220 are placed on the subassembly in that order, with the side plate portion 212 of the top frame 210 located at an outer side of the side plate portion 271 of the fastening plate 270. Finally, a screw 500 is inserted into the screw hole 2120 of the side plate portion 212 of the top frame 210 and the screw hole 2710 of the side plate portion 271 of the fastening plate 270 so as to fix the top frame 210 and the fastening plate 270 together. Thereby, the LCD panel 220 is disposed on the plastic frame 230, and is fixed in position by the top frame 210. A display area (not shown) of the display panel 220 is surrounded by the bezel 211 of the top frame 210.

Unlike the above-described conventional LCD device 100, the LCD device 200 employs a fastening plate 270 having a plurality of screws holes 2721, 2722 and 2710, which enable the light source 240, the back plate 260, and the top frame 210 to be assembled together via the screws 300, 400 and 500, respectively. With this configuration, if either of the lamps 241 has to be replaced, this only necessitates removal of the screws 400 and 500 from the screw holes 2722 and 2710. Once the screws 400 and 500 are removed, the combined fastening plate 270 and light source 240 is readily detached from the remainder of the LCD device 200. That is, the process of exchanging either of the lamps 241 does not require disassembly of the whole LCD device 200. Further, the whole light source 240 itself may be conveniently exchanged if needed.

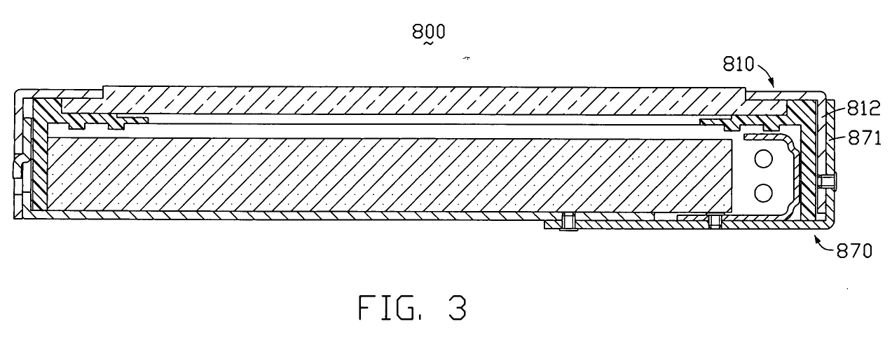

Referring to FIG. 3, an LCD device 800 according to a second embodiment of the present invention has a structure similar to that of the LCD device 200. The LCD device 800 includes a fastening plate 870 having a side plate portion 871, and a top frame 810 having a side plate portion 812. The side plate portion 871 of the fastening plate 270 is located at an outer side of the side portion 812 of the top frame 810. A screw (not labeled) is inserted into a screw hole (not labeled) of the side plate portion 871 and a screw hole (not labeled) of the side plate portion 812 to fix the fastening plate 870 and the top frame 810 together.

In alternative embodiments, any one or more of the screws can instead be a suitable fastener known in the art. In such case, the corresponding one or more screw holes can each instead be a hole configured for receiving the fastener.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a top frame;
a light source comprising at least one lamp and a reflective cover disposed adjacent to the at least one lamp;
a back plate;
a fastening member comprising a bottom plate portion detachably engaged with the back plate and a side plate portion detachably engaged with the top frame, the reflective cover of the light source being engaged with the bottom plate portion; and
a liquid crystal display panel fixed in position above the back plate by the top frame.

2. The liquid crystal display device as claimed in claim 1, wherein the bottom plate portion is detachably fixed to the back plate via a fastener.

3. The liquid crystal display device as claimed in claim 1, wherein the side plate portion is detachably fixed to the top frame via a fastener.

4. The liquid crystal display device as claimed in claim 1, further comprising a light guide plate on the back plate.

5. The liquid crystal display device as claimed in claim 4, wherein the light guide plate comprises a light output surface, a light incident surface adjacent to the light output surface, and a bottom surface opposite to the light output surface, and the light source is disposed adjacent to the light incident surface.

6. The liquid crystal display device as claimed in claim 1, wherein the reflective cover includes a horizontal first plate portion, a vertical second plate portion extending from an end of the first plate portion, and a horizontal third plate portion extending inwardly from a bottom end of the second plate portion.

7. The liquid crystal display device as claimed in claim 6, wherein the third plate portion comprises a fastener hole thereat.

8. The liquid crystal display device as claimed in claim 7, wherein the bottom plate portion of the fastening member comprises a fastener hole, and a fastener is fastened in the fastener hole of the third plate portion and the fastener hole of the bottom plate portion, thereby fixing the reflective cover to the bottom plate portion.

9. The liquid crystal display device as claimed in claim 1, wherein the bottom plate portion of the fastening member comprises a fastener hole, the back plate comprises a fastener hole, and a fastener is fastened in the fastener hole of the bottom plate portion and the fastener hole of the back plate, thereby detachably fixing the fastening member to the back plate.

10. The liquid crystal display device as claimed in claim 1, wherein the top frame comprises a side plate portion, the side plate portion comprises a fastener hole, and the side plate portion of the fastening member comprises a fastener hole corresponding to the fastener hole of the side plate portion of the top frame.

11. The liquid crystal display device as claimed in claim 10, wherein a fastener is fastened in the fastener hole of the side plate portion of the fastening member and the fastener hole of the side plate portion of the top frame, thereby detachably fixing the fastening member to the top frame.

12. The liquid crystal display device as claimed in claim 10, wherein the side plate portion of the top frame is located at an outer side of the side plate portion of the fastening member.

13. The liquid crystal display device as claimed in claim 10, wherein the side plate portion of the fastening member is located at an outer side of the side plate portion of the top frame.

14. The liquid crystal display device as claimed in claim 1, further comprising a plastic frame seated on the fastening member, wherein the liquid crystal display panel is supported on the plastic frame.

15. The liquid crystal display device as claimed in claim 1, wherein the fastening member is made of one of iron, an alloy, and any other metallic material.

16. A liquid crystal display device comprising:
a plastic frame defining essentially a receiving space;
a top frame assembled atop the plastic frame;
a light guide plate disposed in the receiving space and distanced from a plastic frame with a space;
a light source received in said space;
a back plate supportably engaging an underside of the light guide plate; and
a fastening member respectively fastened to the top frame, the bottom plate and the light source so as to hold the light source in position; wherein
the back plate, the top frame and the light source are exposed to an exterior after said fastening member has been disassembled therefrom.

17. A liquid crystal display device comprising:
a plastic frame defining essentially a receiving space;
a top frame assembled atop the plastic frame;
a light guide plate disposed in the receiving space and distanced from a plastic frame with a space;
a light source received in said space;
a back plate supportably engaging an underside of the light guide plate; and
a fastening member respectively fastened to the top frame, the bottom plate and the light source so as to hold said light source in position; wherein
the back plate, the top frame and the light source are not engaged with one another, and the light source together with the light source can be withdrawn from the plastic frame after said fastening member is disassembled from the top frame and the back plate.
